(19) United States
(12) Patent Application Publication
(10) Pub. No.: US 2006/0235586 A1
(43) Pub. Date: Oct. 19, 2006

(54) Diagnostic device

(76) Inventors: Paul J. Waszkowski, Hinckley, OH (US); Craig S. Haehn, Avon Lake, OH (US); David J. Pfefferl, Broadview Heights, OH (US); James P. Porter, Tallmadge, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/109,339

(22) Filed: Apr. 19, 2005

(51) Int. Cl. G06F 19/00

(52) U.S. Cl. 701/29; 340/438

(57) ABSTRACT

A diagnostic device includes a housing, a connector, and a diagnostic unit. The connector is integrated with the housing and is electrically connected to a diagnostic port of a vehicle. A diagnostic electronic control unit is integrated with the housing and electrically communicates with the connector. The diagnostic electronic control unit receives and interprets a power line carrier (PLC) diagnostic message from a vehicle ECU.

### BACKGROUND

The present invention relates to diagnostic devices. It finds particular application in conjunction with diagnostic devices used for vehicles and will be described with particular reference thereto. It will be appreciated, however, that the invention is also amenable to other applications.

Light emitting diodes (LEDs) on-board an electronic control unit (ECU) are used to indicate a finite number of faults on diagnostic devices. Such diagnostic devices are used for indicating faults in electronic systems (e.g., vehicle adaptive braking systems including an antilock braking system (ABS), transmission control systems, engine control systems, etc). An operator may reset and/or auto-configure the ECU (e.g., via a switch). In this sense, the LEDs are used as a first step in diagnosing a failure in an ABS. However, recent trends in locating ABS/automatic traction control (ATC) ECUs have tended to make on-board LEDs non-functional to the user in certain applications (e.g., where LEDs are hidden or difficult to see due to ECU location/orientation). In addition, although LEDs are not always used or desired by buyers, manufacturers tend to include on-board LEDs on all ECUs to accommodate the buyers that do utilize the LEDs. The cost of on-board LEDs introduces unnecessary burdens on ECU manufacturers and buyers in cases where LEDs are not used by the buyers.

For the reasons discussed above, ECUs that do not include diagnostic displays (e.g., on-board LEDs) are becoming more popular. Furthermore, for those customers who desire diagnostic information from the ECU, discrete diagnostic devices have been developed to convey such information to a location remote from the ECU. For example, a diagnostic communication interface (DCI) unit has been disclosed in U.S. Pat. No. 6,114,952 (“the '952 patent”), which is hereby incorporated by reference.

The DCI unit disclosed in the '952 patent communicates with a data bus (e.g., a serial data bus having a J1587 vehicle diagnostic connector) via a cable. Furthermore, the DCI includes a plurality of LEDs for communicating diagnostic information from the ECU to an operator. However, when used by itself, the DCI of the '952 patent is only capable of interpreting proprietary messages received from the data bus. In order to interpret standard messages received from the ECU over the data bus, the DCI of the '952 patent must communicate with an external processor (e.g., a PC) via a port connector.

Other current discrete diagnostic devices also communicate with the J11587 vehicle diagnostic connector. However, these devices are not capable of interpreting power line control (PLC) messages without the use of an interface computing device between the discrete diagnostic device and the vehicle ECU. Furthermore, none of the currently available discrete diagnostic devices is capable of directly communicating with a vehicle trailer without the use of an interface computing device between the discrete diagnostic device and the trailer ECU or without an external power source.

The present invention provides a new and improved apparatus and method which addresses the above-referenced problems.

### SUMMARY

In one embodiment, a diagnostic device includes a housing, a connector, and a diagnostic ECU. The connector is integrated with the housing and is electrically connected to a diagnostic port of a vehicle. The diagnostic ECU is integrated with the housing and electrically communicates with the connector. The diagnostic ECU receives and interprets a PLC diagnostic message from a vehicle ECU.

In another embodiment, a diagnostic system on a vehicle includes a vehicle ECU associated with a system on the vehicle, a diagnostic port, a communication line, which supports PLC signals for communicating electrical signals between the vehicle ECU and the diagnostic port, and a diagnostic device. The diagnostic device includes a housing, a connector, which is integrated with the housing and electrically connected to the diagnostic port, and a diagnostic ECU, which is integrated with the housing and electrically communicates with the connector. The diagnostic ECU receives and interprets a PLC diagnostic message from the vehicle ECU.

In another embodiment, a diagnostic adapter includes a first electrical socket, which electrically communicates with a communication line of a first segment of a heavy vehicle, and a second electrical socket, which is integrally and electrically connected to a diagnostic device. An ECU on the first segment of the heavy vehicle transmits a PLC diagnostic message to the diagnostic device via the communication line, the first electrical socket, and the second electrical socket.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates a first view of a diagnostic device in accordance with one embodiment of the present invention;

FIG. 2 illustrates a second view of a diagnostic device in accordance with one embodiment of the present invention;

FIG. 3 illustrates a schematic diagram of the diagnostic device;

FIG. 4 illustrates a diagnostic port on a vehicle in accordance with one embodiment of the present invention;

FIG. 5 illustrates a schematic diagram of the vehicle including the diagnostic device in accordance with one embodiment of the present invention;

FIG. 6 illustrates an adapter in accordance with one embodiment of the present invention;

FIGS. 7-9 illustrates various cross-sectional views of the adapter; and

FIG. 10 illustrates the diagnostic device and adapter in accordance with a second embodiment of the present invention.

### DETAILED DESCRIPTION OF ILLUSTRATED EMBODIMENT

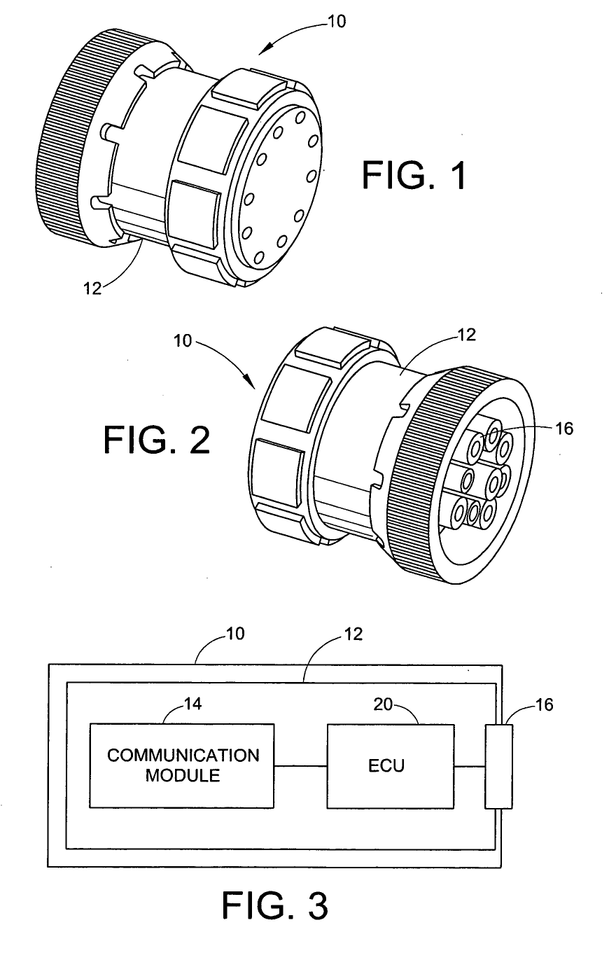

With reference to FIGS. 1-3, a diagnostic device 10 is illustrated in accordance with one embodiment of the present invention. The diagnostic device 10 includes a housing 12 and a communication module 14 (e.g., one or more light emitting diodes (LEDs) and/or a wireless transmitter), which acts as a means for communicating a user message to a user, integrated into the housing 12. A connector 16 and a diagnostic ECU 20, which acts as a means for receiving and interpreting PLC messages, are also integrated with the housing 12. The diagnostic ECU 20 electrically communicates with the connector 16 and the communication module 14.

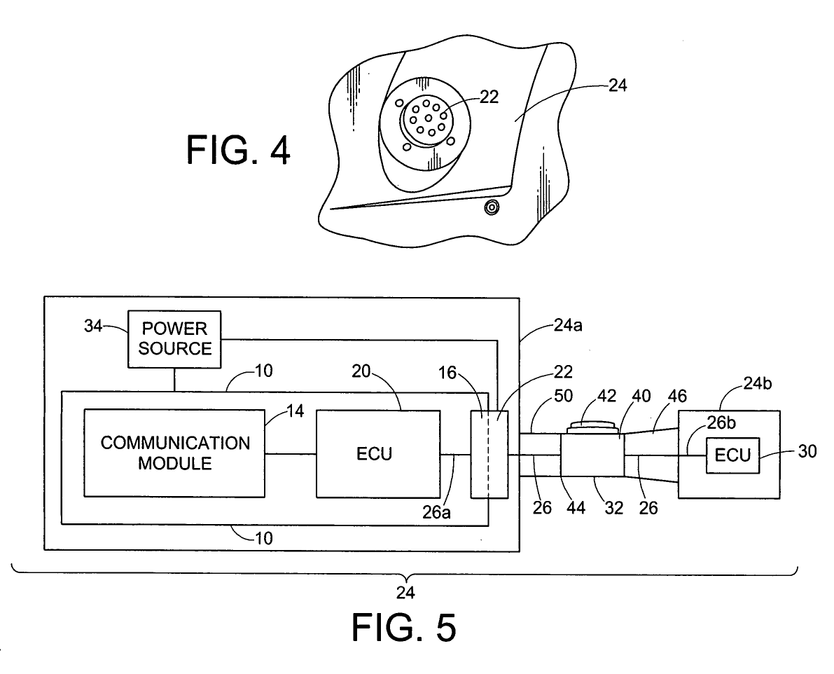

With reference to FIGS. 4 and 5, a diagnostic port 22 on a vehicle 24 (e.g., a heavy vehicle) is illustrated. The connector 16 of the diagnostic device 10 electrically communicates with the diagnostic port 22, which in turn communicates with a communication line 26, 26a, 26b (e.g., a J1939 communication line, a J1587 communication line, etc.) of the vehicle 24. The communication line 26, 26a, 26b is capable of transmitting PLC messages. Various configurations (e.g., seven (7) pins, nine (9) pins, etc.) are contemplated for the connector 16 and the diagnostic port 22. The configuration of the connector 16 is designed to mate with the configuration of the diagnostic port 22.

The diagnostic device 10 and diagnostic port 22 are located in a first segment or portion 24a of the vehicle 24 while a vehicle electronic control unit (ECU) 30 is located in a second segment or portion 24b of the vehicle 24. In one embodiment, the first segment 24a is independent from, but electrically and mechanically connected to, the second segment 24b. For example, in one embodiment, the first segment 24a is a tractor portion of the vehicle 24 while the second segment 24b is a trailer portion of the vehicle 24. The vehicle ECU 30 is used for providing diagnostic information related to the vehicle. For example, the vehicle ECU 30 provides diagnostic information of a vehicle system (e.g., an antilock braking system) indicating a status of various components included in the vehicle system and an overall status of the vehicle system (e.g., whether various sensors in the antilock braking system are operational). The vehicle ECU 30 generates a PLC diagnostic message. The diagnostic message is transmitted in the form of electrical signals from the vehicle ECU 30 to the diagnostic ECU 20 via the communication line 26, 26a, 26b and the diagnostic port 22. As will be discussed in more detail below, an adapter 32 is electrically connected between the communication line 26, 26a, 26b of the first and second segments 24a, 24b, respectively, of the vehicle 24.

Once the diagnostic ECU 20 receives the diagnostic message from the vehicle ECU 30, the diagnostic ECU 20 interprets the message, which indicates an operating status of the vehicle system. The diagnostic ECU 20 determines the user message to be communicated to the user via the communication module 14 as a function of the diagnostic message received from the vehicle ECU 30. In one embodiment, the user message is displayed via LEDs integrated with the housing 12. In another embodiment, the user message is transmitted wirelessly (e.g., via radio-frequency signals transmitted via a radio-frequency transmitter) from the communication module 14 to the user. In this embodiment, it is contemplated that a remote device (not shown), which can be easily viewed by the user, receives the user message and displays an appropriate communication to the user as a function of the user message.

In the embodiment illustrated in FIG. 5, power is supplied to the vehicle ECU 30 from a power source 34 located on the first segment 24a of the vehicle 24. In this case, electrical power is supplied from the power source 34 to the vehicle ECU 30 via the adapter 32. At the same time, electrical power is supplied from the power source 34 to the diagnostic device 10 (including the diagnostic ECU 20) via the connector 16 and the diagnostic port 22.

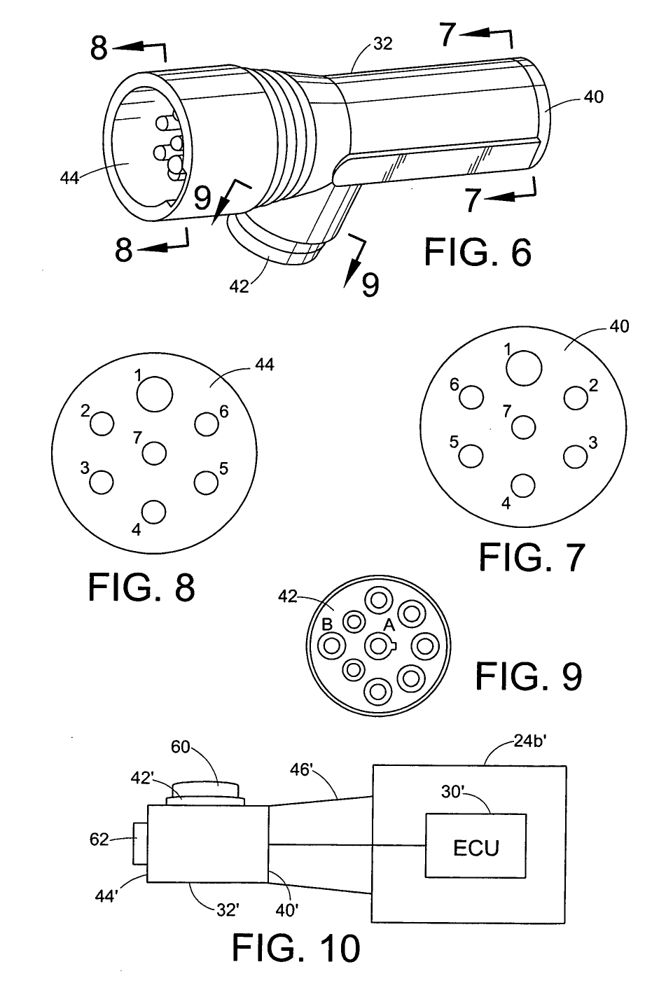

With reference to FIGS. 5-9, the adapter 32 includes first, second, and third electrical connectors 40, 42, 44, respectively. The first and third electrical connectors 40, 44, respectively, include pin configurations for mating with electrical sockets 46, 50, respectively, on the second and first segments 24b, 24a of the vehicle 24. Therefore, the first electrical connector 40 is connected to the electrical socket 46 on the second segment 24b of the vehicle 24 for electrically communicating with the communication line 26b in the second segment 24b of the vehicle. Also, the third electrical connector 44 is connected to the electrical socket 50 on the first segment 24a of the vehicle 24 for electrically communicating with the communication line 26a in the first segment 24a of the vehicle. In the illustrated embodiment, the adapter 32 provides a means for electrically connecting the communication line 26, 26a, 26b of the first and second segments 24a, 24b of the vehicle.

The second electrical connector 42 of the adapter 32 is configured for mating with the connector 16 (see FIG. 2) of the diagnostic device 10 and, furthermore, electrically connecting the diagnostic device 10 to the communication line 26, 26a, 26b of the vehicle 24. Therefore, although the diagnostic device 10 is illustrated as being integrally connected to the diagnostic port 22 in the first segment 24a of the vehicle, it is to be understood that the diagnostic device 10 may, instead, be integrally and electrically connected to the second electrical socket 42 of the adapter 32 for resulting in equivalent functionality.

FIGS. 7-9 illustrate respective cross-sectional views of the electrical connectors 40, 42, 44. The connectors 40, 44 each include seven (7) pins (as labeled) for mating with the electrical sockets 46, 50. The connector 42 includes nine (9) pins for mating with the connector 16. It is to be understood that other pin configurations are also contemplated.

With reference to FIG. 10, another embodiment of the present invention is illustrated. For ease of understanding this embodiment of the present invention, like components are designated by like numerals with a primed (′) suffix and new components are designated by new numerals. In this embodiment, the second segment 24b′ of the vehicle is not mechanically or electrically connected to the first segment (not shown) of the vehicle. The first electrical connector 40′ of the adapter 32′ is electrically connected to the second segment 24b′ of the vehicle via 46′ and the second electrical connector 42′ of the adapter 32′ is integrally and electrically connected to a diagnostic device 60. The third electrical connector 44′ of the adapter 32′ is electrically connected to an external power source 62 that supplies electrical power to the diagnostic device 60 and the vehicle ECU 30′.

It is to be understood that the embodiment illustrated in FIG. 10 is useful for receiving diagnostic messages from the vehicle ECU 30′ when the second segment 24b′ of the vehicle is not electrically connected to the power source 34 (see FIG. 5) in the first segment 24a (see FIG. 5) of the vehicle.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

1. A diagnostic device, comprising:
a housing;
a connector, integrated with the housing, electrically connected to a diagnostic port of a vehicle; and
a diagnostic ECU, integrated with the housing, and electrically communicating with the connector, receiving and interpreting a power line carrier (PLC) diagnostic message from a vehicle ECU.

2. The diagnostic device as set forth in claim 1, further including:
a display, integrated with the housing, for displaying a user message as a function of the diagnostic message from the vehicle ECU.

3. The diagnostic device as set forth in claim 2, wherein the display includes a light emitting diode.

4. The diagnostic device as set forth in claim 1, wherein the connector is configured for electrically communicating with at least one of a J1939 and a J1587 connector on the vehicle.

5. The diagnostic device as set forth in claim 1, wherein the diagnostic ECU receives the diagnostic message from a trailer portion of the vehicle.

6. The diagnostic device as set forth in claim 1, wherein the diagnostic ECU receives electrical power via the connector and the diagnostic port.

7. The diagnostic device as set forth in claim 1, further including:
a transmitter, integrated into the housing, for wirelessly transmitting a signal indicative of the diagnostic message.

8. A diagnostic system on a vehicle, the system comprising:
a vehicle electronic control unit (ECU) associated with a system on the vehicle;
a diagnostic port;
a communication line, that supports power line carrier (PLC) signals, for communicating electrical signals between the vehicle ECU and the diagnostic port;
a diagnostic device, including:
a housing;
a connector, integrated with the housing, electrically connected to the diagnostic port; and
a diagnostic ECU, integrated with the housing and electrically communicating with the connector, receiving and interpreting a power line carrier (PLC) diagnostic message from the vehicle ECU.

9. The diagnostic system on a vehicle as set forth in claim 8, further including:
means for displaying a user message as a function of the diagnostic message from the vehicle ECU.

10. The diagnostic system as set forth in claim 9, wherein the means for displaying is integrated into the housing.

11. The diagnostic system as set forth in claim 9, wherein the means for displaying includes a light emitting diode.

12. The diagnostic system as set forth in claim 8, wherein:
the diagnostic device is located in a first portion of the vehicle; and
the vehicle ECU is located in a second, independent portion of the vehicle.

13. The diagnostic system as set forth in claim 12, wherein:
the vehicle is a heavy vehicle;
the first portion of the vehicle is a tractor portion; and
the second portion of the vehicle is a trailer portion.

14. The diagnostic system as set forth in claim 8, wherein the diagnostic message indicates a diagnostic status of an antilock braking system of the trailer.

15. The diagnostic system as set forth in claim 8, wherein the system on the vehicle is an antilock braking system.

16. The diagnostic system as set forth in claim 8, wherein the diagnostic device further includes:
a radio-frequency circuit, integrated into the housing, for transmitting a radio-frequency signal indicative of the diagnostic message.

17. The diagnostic system as set forth in claim 8, wherein the diagnostic device is powered by a vehicle power supply that electrically communicates with the diagnostic port.

18. The diagnostic system as set forth in claim 8, wherein the vehicle ECU and the communication line are included on a trailer of a heavy vehicle, the diagnostic system further including an adapter having:
a first electrical socket electrically connected to a trailer electrical socket, which electrically communicates with the communication line; and
a second electrical socket, the diagnostic device being electrically connected to the communication line of the trailer via the first and second electrical sockets of the adapter, and
a third electrical socket.

19. The diagnostic system as set forth in claim 18, wherein the adapter includes: a-third electrical socket electrically connected to an external power source for supplying electrical power to the diagnostic device.

20. The diagnostic system as set forth in claim 18, wherein the adapter includes: a third electrical socket electrically connected to a tractor of the heavy vehicle, a vehicle power supply on the tractor powering the diagnostic device via the third electrical socket.

21. A diagnostic adapter, comprising:
a first electrical socket electrically communicating with a communication line of a first segment of a heavy vehicle;
a second electrical socket integrally and electrically connected to a diagnostic device, an electronic control unit (ECU) on the first segment of the heavy vehicle transmitting a power line carrier (PLC) diagnostic message to the diagnostic device via the communication line, the first electrical socket, and the second electrical socket and
a third electrical socket.

22. The diagnostic adapter as set forth in claim 21, further comprising: third electrical socket electrically connected to an external power source for supplying electrical power to the diagnostic device.

23. The diagnostic adapter as set forth in claim 21, further comprising: a third electrical socket electrically connected to a second segment of the heavy vehicle, a power source on the second segment supplying electrical power to the diagnostic device.

24. The diagnostic adapter as set forth in claim 213, wherein the first and third electrical sockets include seven pins.

25. A method for diagnosing a system on a vehicle, the method comprising:
connecting a diagnostic electronic control unit (ECU) to an adapter;
supplying electrical power to a vehicle ECU via a power source through the adapter;
generating a power line carrier (PLC) diagnostic message within the vehicle ECU;
transmitting the diagnostic message from the vehicle ECU to the diagnostic ECU through the adapter via a power line;
receiving the diagnostic message into the diagnostic ECU; and
interpreting the diagnostic message within the diagnostic ECU.

26. The method for diagnosing a system on a vehicle as set forth in claim 25, further including:
supplying electrical power to the vehicle and diagnostic ECUs via an external power source electrically connected to the vehicle and diagnostic ECUs via the adapter.

27. The method for diagnosing a system on a vehicle as set forth in claim 25, wherein the adapter is located between a first segment of the vehicle and a second segment of the vehicle, and
the power source is located in the first segment of the vehicle.

28. The method for diagnosing a system on a vehicle as set forth in claim 25, further including:
displaying a message, as a function of the diagnostic message, on the diagnostic ECU.

29. The method for diagnosing a system on a vehicle as set forth in claim 25, further including:
wirelessly transmitting a signal, as a function of the diagnostic message, from the diagnostic ECU.

30. A diagnostic device, comprising:
a housing;
a connector, integrated with the housing, electrically connected to a diagnostic port of a vehicle; and
means for receiving and interpreting a power line carrier (PLC) diagnostic message from a vehicle ECU, the means for receiving and interpreting being integrated with the housing and electrically communicating with the connector
